(19) United States
(12) Patent Application Publication
(10) Pub. No.: US 2011/0078328 A1
(43) Pub. Date: Mar. 31, 2011

(54) MODULE COMMUNICATION

(76) Inventors: Jonathan Mark Dunsdon, Warwickshire (GB); Benjamin James Sykes, Shropshire (GB)

(21) Appl. No.: 12/881,400

(22) Filed: Sep. 14, 2010

(30) Foreign Application Priority Data
Sep. 25, 2009 (GB) 0916869.1

(51) Int. Cl. G06F 15/173

(52) U.S. Cl. 709/238

(57) ABSTRACT

A communication network for communicating between a plurality of modules is disclosed. Each module is arranged to be connected to or associated with one of the plurality of communication gateways and each communication gateway is connectable to at least one other communication gateway. The communication gateways each have a dynamic module naming list to enable the communication gateway to determine a route to direct a message to an appropriate recipient module using the recipient module's local communication gateway.

### CROSS-REFERENCE TO RELATED APPLICATIONS

This application claims priority under 35 U.S.C. §119(a)-(d) or (f) to prior-filed, co-pending British patent application serial number 0916869.1, filed on Sep. 25, 2009, which is hereby incorporated by reference in its entirety.

### BACKGROUND OF THE INVENTION

1. Field of Invention

The present invention relates to module communication, such as communication between modules in a network.

2. Description of the Prior Art

Many systems have a network for modules within the system to be able to communicate with each other. For example an aircraft, a ship, a piece of machinery such as a turbine, a factory and a hospital have modules that need to communicate with each other. In an aircraft for example there are various modules such as an engine controller, an engine monitoring unit, an aircraft monitoring unit and a ground station that need to communicate with each other.

Conventionally a central locator may be used which is connected to each of the modules to handle communications between them. However, as all of the modules are connected via the central locator, this provides a single point of failure which is not suitable for important or critical systems. Alternatively, modules may be connected together in a distributed network with each module having a list or table indicating the route to be taken within the network to communicate with another particular module. However, when a module is removed or a new module is added, the list or table for every module in the network needs to be manually updated which is a time consuming exercise, resulting in long and frequent downtimes for the system which is generally inconvenient.

It is desirable to overcome or alleviate at least some of the problems associated with communication between the modules discussed above.

### SUMMARY OF THE INVENTION

According to a first aspect of the present invention, there is provided a communication network for communicating between a plurality of modules, wherein each module is arranged to be connected to or associated with a communication gateway each communication gateway being connectable to at least one other communication gateway forming the network; and each communication gateway has a dynamic module naming list to enable it to direct a message to an appropriate recipient module via directly connected communication gateways within the network.

The dynamic module naming list of each communication gateway is automatically updated as to the status of modules in the network, such as by the addition or removal of a module and so does not require time consuming manual updating.

When a module is added to the network, it is arranged to register with a communication gateway so that the dynamic module naming list for that gateway is then updated. The registration of the added module to this gateway is sent to all directly connected gateways and cascaded to all other gateways in the network so that the dynamic module naming list of each communication gateway in the network includes the added module. The dynamic module naming list for each gateway in the network preferably holds at least one route to every module in the network.

When a module shuts down, it is arranged to send a de-register message to alert gateways in the network that it is no longer available. If a link between gateways is lost or closed, any routes in dynamic module naming lists including that link are removed. Conversely, if a link between gateways is added, route updates are announced.

As each communication gateway has a dynamic module naming list which is automatically updated by the addition or removal of a module and as this update is sent to all directly connected gateways and cascaded to all other gateways in the network, a comprehensive current dynamic module naming list is available to all modules. Reliable communications are thus achieved without having to manually input updated data to each communication gateway in the network and without having to rely on a single central locator which results in a single point of failure.

According to a second aspect of the present invention there is provided a communication gateway for a network. The communication gateway includes a dynamic module naming list to enable the communication gateway to direct a message to an appropriate recipient module via directly connected gateways within the network.

According to a third aspect of the present invention there is provided a method of communicating between a plurality of modules in a network, each module being arranged to be connected to or associated with a communication gateway, each communication gateway being connectable to at least one other communication gateway forming the network; and each communication gateway having a dynamic module naming list to enable it to determine a route to direct a message to an appropriate recipient module via at least one directly connected gateway within the network, the method comprising: passing a message from a module to its local communication gateway; determining a route to a destination module from the dynamic module naming list of the local gateway and forwarding the message to the next communication gateway or module indicated in the route determined from the dynamic module naming list.

### BRIEF DESCRIPTION OF THE DRAWINGS

Examples of the present invention will now be described with reference to the accompanying drawings, in which:

FIG. 1 illustrates a first example of a communication network for communication between a plurality of modules;

FIG. 2 illustrates a second example of a communication network for communication between a plurality of modules; and

FIG. 3 is a flow diagram illustrating how dynamic module naming lists are updated when a module is added to the network.

### DETAILED DESCRIPTION OF THE INVENTION

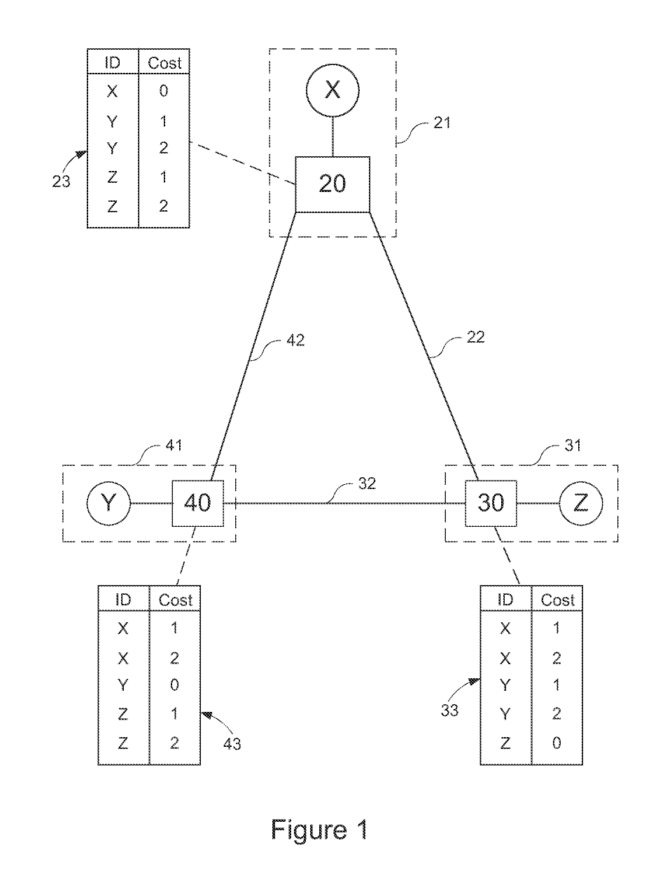

FIG. 1 illustrates a network 10 for communicating between modules X, Y and Z. The modules may take the form of any device which needs to communicate with another device. For example, in an aircraft an engine controller, an engine monitoring unit, an aircraft monitoring unit and a ground station may need to communicate with each other and in a turbine a turbine controller may need to communicate with a power controller and a safety controller for example. In the example of FIG. 1, each unit X, Y and Z is connected to a corresponding communication gateway 20, 30, 40. The module X, Y, Z and its corresponding respective gateway, 20, 30, 40 form a unit 21, 31, 41 shown in dashed lines in FIG. 1. Each communication gateway 20, 30, 40 is connected 22, 32, 42 to at least one other communications gateway. The connection may take any form and may be by a physical link such as a wire or an optical fibre or via a radio signal for example. Each gateway 20, 30, 40 has a dynamic module naming list 23, 33, 43 to enable it to direct a message to an appropriate recipient module X, Y, Z via directly connected communication gateways within the network. For example, dynamic module naming list 23 for communication gateway 20 includes a left hand column indicating the modules registered in the network and the right hand column indicates the cost or number of other communication gateways that need to be passed through to reach the recipient module. Each communication gateway 20, 30, 40 has an appropriate dynamic module naming list which is automatically updated as to the operational or active modules currently in the network. Each dynamic module naming list is preferably updated and maintained by the addition or removal of a module to or from the network 10 requiring automatic registration or de-registration with its corresponding communication gateway which is cascaded to all other communication gateways in the network 10.

Communication gateways 20, 30, 40 are preferably implemented by a software application but may take any form such as a hard wired logic circuit. The communication gateways 20, 30, 40 connect to other communication gateways and act as message handlers. Modules X, Y, Z only connect to their local gateway. More than one module may be connected to a single communication gateway as illustrated in the next example. Communication gateways allow modules to reside on different physical devices without needing to know the exact location of other modules or the networking topology. By using dynamic registration, modules can be started on any device and moved from one device to another while the system is running without needing to re-configure any modules.

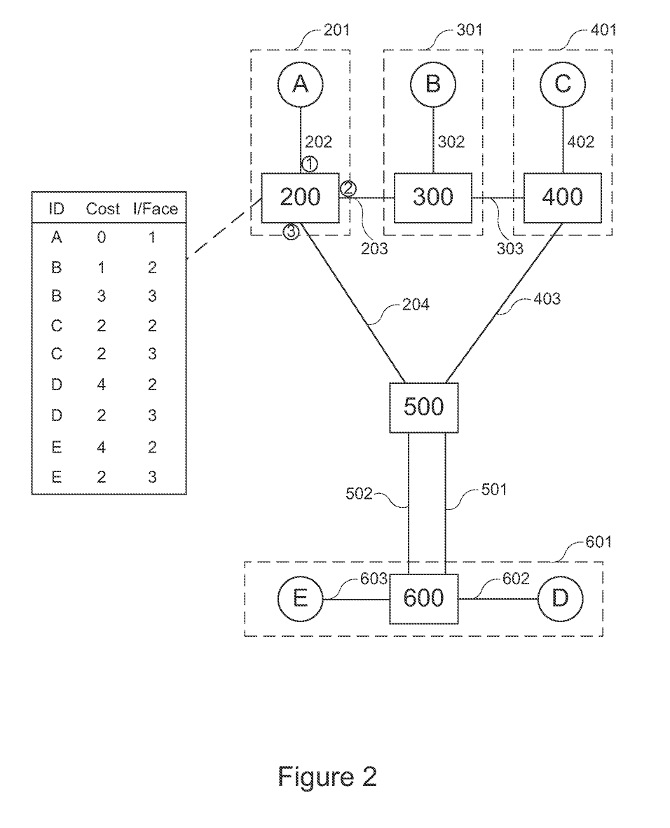

FIG. 2 shows a more detailed example of a communication network of an example of the present invention. In this example there are five modules A, B, C, D and E. The modules may be part of the systems of an aircraft for example and module A may be an engine controller which may obtain data about the engine, such as the speed of the shaft, the temperature of the engine at various points and the vibration at various points or of various components. Module B may for example be an engine monitoring unit which may process raw data into averages. Module C may be an aircraft monitoring unit which may for example check average values for various situations such as for take-off, cruising and landing situations. Modules D and E may be based in a ground station and may be arranged to analyse and store data for example to determine long term trends in the aircraft such as for determining maintenance schedules.

As can be seen from FIG. 2, each module A, B, C, D, E is connected to an associated communication gateway 200, 300, 400, 500, 600. In this example communication gateway 500 does not have an associated module and has two connections to neighbouring communication gateway 600 at a ground station 601. The first connection 501 may for example be for radio communications whilst the aircraft is in the air and the second connection 502 may be a physical connection for when the aircraft has landed.

Whilst each communication gateway 200, 300, 400, 500, 600 will have its own dynamic module naming list, only the dynamic module naming list 204 for communication gateway 200 is shown in this example. As can be seen, the left hand column of the list indicates each of the current modules A, B, C, D, E currently registered in the network 100 that can be communicated with. The next column indicates the cost or number of communication gateways that have to be passed through for a communication to reach its destination and the third column indicates the interface or socket on the communication gateway that connects with that particular selected route for the desired module. Each interface connects to either a module or a communication gateway. In the example of FIG. 2, communication gateway 200 has three interfaces. Interface 1 connects to module A, interface 2 connects with communication gateway 300 and interface 3 connects with communication gateway 500. As explained earlier, the dynamic module naming list for each communication gateway provides a route table of ways to forward messages to every other module currently registered in the network. Each of the other communication gateways 300, 400, 500, 600 will have its own corresponding dynamic module naming list (not shown).

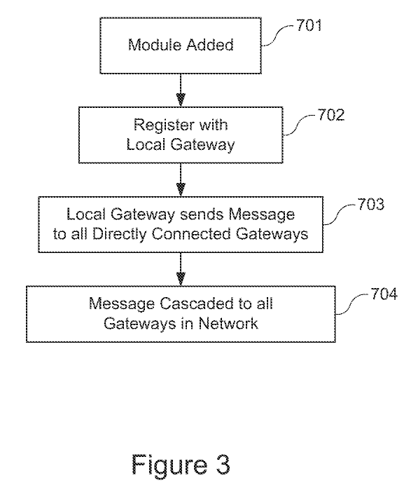

As illustrated in the flow diagram of FIG. 3, when a module is added to the network at step 701, the module registers with a local gateway at step 702. The communication gateway then sends the registration of the new module to all directly connected communication gateways at step 703 and at step 704 a message advising all other gateways to update their dynamic module naming lists is cascaded at step 704 until all communication gateways in the network have updated dynamic module naming lists. Conversely, when a module shuts-down a de-register message is passed to its local gateway which is forwarded on to directly connected gateways and cascaded to all gateways in the network to alert all dynamic module naming lists in communication gateways of the network that it is no longer available. If a link is lost or closed or a new link is added, any routes using that link are removed or added appropriately and route updates are cascaded to dynamic module naming lists of all connected gateways. The dynamic module naming list of each communication gateway in the network 100 holds at least one route to every module in the network.

Referring back to FIG. 2, when a module such as module A sends a message to another module, the sending module passes the message to its local communication gateway, in this case 200, with a gateway header prefixed to the message that indicates the destination module for the message. As all communication gateways have a dynamic module naming list listing all modules in the system, the destination module is looked up in its dynamic module naming list to find the most appropriate way to forward the message to the destination module. The dynamic module naming list indicates the route with the least number of gateways to pass through to reach the destination module. The communication gateways will forward the message towards the destination until the destined module receives the message.

With reference to the example of FIG. 2, the engine controller A may periodically send measured engine parameters such as the speed of a shaft and the temperature and vibration at various points to the engine monitoring unit module B. The message would be received by communication gateway 200 and its dynamic module naming list 204 would indicate that the shortest route to module B would be via interface 2 and so the message is forwarded from this interface to communication module 300 which would receive the message, determine the destination to be module B and forward the message along link 302 after referring to its own dynamic module naming list (not shown). Engine monitoring unit B may process the raw data received from engine controller A in an appropriate way such as by producing averages, standard deviations etc. The processed data from engine monitoring unit B may periodically be passed to the aircraft monitoring unit C in a similar manner using the dynamic module naming lists of communication gateways 300, 400. Information may be periodically passed to the ground station 601 or requested from the ground station 601 and passed from engine controller A and aircraft monitoring unit C. In these situations the communication gateway for the appropriate module would access its dynamic module naming list and forward the message by the most appropriate route with any communication gateways passed along the route forwarding the message accordingly until the message reaches its destination module.

Use of the dynamic module naming list enables modules to be identified by any convenient name rather than an identification code allowing for modules to be moved without having to know the exact location and the moved modules can de-register and register using their name.

The automatic updating of the dynamic module naming list of each communication gateway provides reliable communication between modules within a network without requiring time consuming manual updating of route lists associated with each module in the network.

Many modifications may be made to the examples described above without departing from the scope of the invention. For example, the invention may be applied to any communication network in which modules are provided such as a network in an office or at a facility such as a factory or hospital or a network for a specific item such as an aircraft, a ship or a piece of machinery such as a turbine. The dynamic module naming list includes a route for each module registered with the network and may include information such as the number of steps to reach a destination module, the particular interface or socket of the communication gateway connected to a particular route and further information for a particular route such as a route with a radio link only to be used when an alternative link with a physical connection is not available to reduce costs associated with use of the more expensive radio link.

What is claimed is:

1. A communication network, comprising:
a plurality of communication gateways; and
a plurality of modules, each module being arranged to be connected to or associated with one of the plurality of communication gateways, each communication gateway being connectable to at least one other communication gateway,
wherein each communication gateway has a dynamic module naming list to enable the communication gateway to determine a route to direct a message to an appropriate recipient module using the recipient module's local communication gateway.

2. The network according to claim 1, wherein each dynamic module naming list is automatically updated as to the available modules in the network.

3. The network according to claim 1, wherein each dynamic module naming list is automatically updated when a module is added to or removed from the network.

4. A network according to claim 1, wherein when a module is added to the network, the module is arranged to connect or associate with a first communication gateway such that the dynamic module naming list for the first communication gateway is updated and the connection or association of the module is sent to all communication gateways directly connected to the first communication gateway and cascaded to all communication gateways in the network to update the communication gateway's dynamic module naming lists.

5. A network according to claim 1, wherein when a module shuts down, the module is arranged to alert a local communication gateway to which it is connected that it is no longer available such that the dynamic module naming list for the local communication gateway is updated and the information is sent to all communication gateways directly connected to the local communication gateway and cascaded to all communication gateways in the network to update the communication gateway's dynamic module naming lists.

6. A communication gateway for a network according claim 1, comprising a dynamic module naming list to enable the communication gateway to direct a message to a recipient module using the recipient module's local communication gateway.

7. A method of communicating in a network, the network comprising a plurality of communication gateways; and a plurality of modules, each module being arranged to be connected to or associated with one of the plurality of communication gateways, each communication gateway being connectable to at least one other communication gateway, wherein each communication gateway has a dynamic module naming list to enable the communication gateway to determine a route to direct a message to an appropriate recipient module using the recipient module's local communication gateway, the method comprising:
directing a message from a module to the module's local communication gateway;
determining a route to a destination module from the dynamic module naming list of the local communication gateway; and
forwarding the message to the next communication gateway or module indicated in the route determined from the dynamic module naming list.
